(19) United States
(12) Patent Application Publication
(10) Pub. No.: US 2016/0130385 A1
(43) Pub. Date: May 12, 2016

(54) POLYOL FORMULATIONS CONTAINING FILLERS AND POLYURETHANES PRODUCED THEREFROM

(71) Applicant: COVESTRO DEUTSCHLAND AG, Leverkusen (DE)

(72) Inventors: Wolfgang BRENNECKE, Bergisch Gladbach (DE); Joachim KUERSCHNER, Leverkusen (DE); Klaus PLEISS, Bergisch Gladbach (DE); Heike SCHMIDT, Leverkusen (DE); Yusuf KOEKTAS, Köln (DE); Bernd ROTHE, Köln (DE)

(21) Appl. No.: 14/896,009

(22) PCT Filed: Jun. 2, 2014
(86) PCT No.: PCT/EP2014/061326

§ 371 Date: Dec. 4, 2015

(30) Foreign Application Priority Data
Jun. 7, 2013 (EP) 13171107.9

(51) Int. Cl. C08G 18/08; C08K 3/34; C09D 175/08; C08G 18/10; C08G 18/66; C08K 3/26; C08K 3/22

(52) U.S. Cl. CPC C08G 18/0838; C08K 3/26; C08K 3/346; C08K 3/22; C08G 18/10; C08G 18/6629; C09D 175/08; C08K 2003/265; C08K 2003/2227

(57) ABSTRACT

The invention relates to polyol formulations containing fillers, to polyurethanes produced therefrom, to components having said polyurethanes containing fillers, and to a method for producing the components, in particular using spray technology.

The present invention relates to filler-containing polyol formulations, to polyurethanes produced therewith and to components comprising these filler-containing polyurethanes, and also to a process for producing the components, especially by spray methodology.

The use of fillers enables exact adjustment of the mechanical properties of polyurethanes produced therewith. To achieve a high modulus of elasticity of more than 6000 MPa, a high filler content is required here. The processing of systems with a high filler content in polyurethane spray methodology requires complex adaptation of the processing systems and starting components in order to assure continuous and reproducible processing in production.

In EP-A 0728 574, mica is used as filler. In this patent application, a proportion of 10% to 55% by weight of mica is used, based on the polyurethane mixture. A disadvantage when using mica is that a high modulus of elasticity of, for example, >6000 MPa cannot he achieved. Furthermore, mica has a high density of more than 2800 kg/m³. Thus, it is not possible to produce components having a high filler level and simultaneously low specific weight.

U.S. Pat. No. 7,842,349 describes a polyurethane system in which the fillers are used both in the polyol component and in the isocyanate component. The use in both components enables a high filler content of more than 40% by weight, based on the overall polyurethane system. However, the preparation of the fillers and the incorporation of the fillers, particularly into the isocyanate component, is very complex. There is no description of the sole use of the fillers in the polyol component in correspondingly higher amounts.

WO 2004/065469 describes, for casting systems based on epoxides, the combination of different fillers for attainment of homogeneous viscosities in the polyurethane. The casting systems described are cast here, and so viscosities in the overall system of more than 5000 mPas are processible without difficulty. However, such viscosities cannot be sprayed in a polyurethane spray process, since conveying in the plants is impossible given such high viscosities, nor is the creation of a homogeneous spray profile achievable. Furthermore, this document describes fillers such as quartz flour, for example, which would lead to rapid destruction of the plants in the spray process at pressures of 160 bar in some cases. In WO 2004/1065469, fillers wherein the fines fraction has a median particle diameter (d₅₀) of 2.53 μm are used.

It was therefore an object of the present invention to provide a polyol formulation having a high filler content, with which polyurethanes having a correspondingly high filler content can be produced and where no sedimentation occurs. In addition, it is to be possible to use the filler-containing polyol formulation in a blend with one or more di- and/or polyisocyanates in spray methodology without difficulty.

It has been found that, surprisingly, this object is achieved by the combination of coarse and fine fillers.

The invention provides a filler-containing polyol formulation consisting of

i) a polyol component having a number-average OH number of 250 to 600 mg KOH/g and a number-average functionality of 2.5 to 5, containing at least one or more than one polyol,

ii) optionally chain extenders and/or crosslinkers,

iii) optionally catalysts and/or activators,

iv) optionally assistants and/or additives,

v) optionally blowing agents,

vi) at least one filler from the group consisting of calcium carbonate, kaolinite, aluminum hydroxide and talc in an amount of 50% to 75% by weight, based on the polyol formulation,

wherein a coarse fraction of filler particles having d₅₀ of 30 to 80 μm in an amount of 80% to 97.5% by weight, based on the filler, and a fine fraction of filler particles having d₅₀ of 0.5 to 2 μm in an amount of 2.5% to 20% by weight, based on the filler, are present and the filler does not sediment for up to 40 days at 20° C., and wherein the viscosity of the polyol formulation at 70° C. is below 5000 mPas (to DIN EN ISO 2555 at 70° C.).

The invention further provides a filler-containing polyurethane comprising the reaction mixture of
a) a filler-containing polyol formulation consisting of
   i) a polyol component having a number-average OH number of 250 to 600 mg KOH/g and a number-average functionality of 2.5 to 5, containing at least one or more than one polyol,
   ii) optionally chain extenders and/or crosslinkers,
   iii) optionally catalysts and/or activators,
   iv) optionally assistants and/or additives,
   v) optionally blowing agents,
   vi) at least one filler from the group consisting of calcium carbonate, kaolinite, aluminum hydroxide and talc in an amount of 50% to 75% by weight, based on the polyol formulation,
   wherein a coarse fraction of particles having d₅₀ of 30 to 80 μm in an amount of 80% to 97.5% by weight, based on the filler, and a fine fraction of particles having d₅₀ of 0.5 to 2 μm in an amount of 2.5% to 20% by weight, based on the filler, are present and the filler does not sediment for up to 40 days at 20° C., and wherein the viscosity of the polyol formulation at 70° C. is below 5000 mPas (to DIN EN ISO 2555 at 70° C.), and
b) at least one di- and/or polyisocyanate component.

The invention further provides components consisting of at least one filler-containing polyurethane of the invention and optionally a substrate or one or more layers.

The invention further provides components consisting of at least one filler-containing polyurethane of the invention and a substrate or one or more layers.

The invention further provides composite components consisting of at least one layer of a filler-containing polyurethane of the invention and at least one further layer.

The invention further provides a process for producing the composite components of the invention, having at least one filler-containing polyurethane layer formed from a filler-containing polyol formulation and at least one di- and/or polyisocyanate component and at least one substrate or a further layer, by spray methodology, characterized in that
a) at least one filler from the group consisting of calcium carbonate, kaolinite, talc and aluminum hydroxide in an amount of 50% to 75% by weight, based on the filler-containing polyol formulation, is blended with a polyol formulation consisting of
   i) a polyol component having a number-average OH number of 250 mg KOH/g to 600 mg KOH/g and a mean functionality of 2.5 to 5, containing one or more polyols,
   ii) optionally chain extenders and/or crosslinkers,
   iii) optionally catalysts and/or activators,
   iv) optionally assistants and/or additives,
   v) optionally blowing agents,
to give a filler-containing polyol formulation having a viscosity at 70° C. of less than 5000 mPas (to DIN EN ISO 2555 at 70° C.), wherein a coarse fraction of filler particles having d₅₀ of 30 to 80 μm in an amount of 80% to 97.5% by weight, based on the filler, and a fine fraction of filler particles having d₅₀ of 0.5 to 2 μm in an amount of 2.5% to 20% by weight, based on the filler, are present and the filler does not sediment for up to 40 days at 20° C.,
b) the filler-containing polyol formulation from a) is mixed in a spray head with at least one di- and/or polyisocyanate component to give a mixture,
c) the mixture from b) is sprayed onto a substrate or a layer and cured.

The fillers used in accordance with the invention are calcium carbonate, kaolinite, aluminum hydroxide and talc. These fillers are neutral with respect to the polyurethane reaction. The Mohs hardness of the fillers is below a value of 3, and so it is possible in principle to process the polyurethane reactive mixture together with these fillers in spray systems. In the case of Mohs hardnesses above 3, system wear is excessive and the spray operation would thus be technically unviable. A further important factor for processibility is the viscosity of the polyol formulation, which should be below 5000 mPas at 70° C. (to DIN EN ISO 2555 at 70° C.), preferably between 2000 and 5000 mPas, more preferably between 2500 and 5000 mPas.

The fillers used are part of the group of the calcium carbonates (chemical formula CaCO₃), kaolinite (chemical formula Al₄[(OH)₈]Si₄O₁₀), aluminum hydroxides (chemical formula Al(OH)₃) and talc (chemical formula Mg₃[Si₄O40H)₂]). The fillers used in the polyol formulation have a coarse fraction and a fine fraction of particles, where the coarse and fine fractions may be present in one filler or the fine fraction may be present in one filler and the coarse fraction in another filler. The median particle diameter d₅₀ is defined in each case as the weighted mean particle diameter by the standards DIN ISO 92764 and −2.

The density of the fillers used is below 2800 kg/m³.

The di- and/or polyisocyanates used in accordance with the invention are preferably aliphatic, cycloaliphatic or aromatic di- and/or polyisocyanates. They are preferably di- and/or polyisocyanates from the diphenylmethane series that are liquid at room temperature. These include mixtures of 4,4f-diisocyanatodiphenylmethane with 2,4′- and optionally 2,2′-diisocyanatodiphenylmethane which are liquid at room temperature and have been correspondingly modified if necessary. Also of good suitability are polyisocyanate mixtures from the diphenylmethane series which are liquid at room temperature and comprise, as well as the isomers mentioned, the higher homologs thereof, and which are obtainable in a manner known per se by phosgenation of aniline/formaldehyde condensates. Also suitable are modification products of these di- and polyisocyanates having urethane and/or carbodiimide groups. Also suitable are modification products of said di- and polyisocyanates having allophanate or biuret groups. The polyisocyanate component preferably has a mean NCO functionality of 2.1 to 5.0, more preferably 2.5 to 3.1.

Preference is given to using, as isocyanate component, a semiprepolymer based on diphenylmethane diisocyanate (MDI) having 20% to 30% by weight of NCO groups.

As well as its function as a formation component for the polyurethane matrix, the polyol component additionally also fulfils the role of a dispersant. The polyols to be used may preferably be the following polyols which are liquid at 10 to 60° C. and are known per se in polyurethane chemistry: polyhydroxy polyethers, polyhydroxy polyesters, polyhydroxy polythioethers, polyhydroxy polyacetals, polyhydroxy polycarbonates, polyhydroxy polyesteramides, polyhydroxy polyamides or polyhydroxy polybutadienes. It is also possible to use polyhydroxyl compounds which already contain urethane or urea groups and optionally modified natural polyols, such as castor oil, as polyol component. It is of course also possible to use mixtures of the abovementioned compounds, for example mixtures of polyhydroxy polyethers and polyhydroxy polyesters.

The polyols used are preferably polyhydroxy polyethers, which can be prepared in a manner known per se by polyaddition of alkylene oxides onto polyfunctional starter compounds in the presence of catalysts. Preferably, the poly(oxyalkylene)polyols used in accordance with the invention are prepared from a starter compound having an average of 3 to 8 active hydrogen atoms and one or more alkylene oxides. Preferred starter compounds are molecules having three to eight hydroxyl groups per molecule, such as triethanolamine, glycerol, trimethylolpropane, pentaerythritol, sorbitol and sucrose. The starter compounds may be used alone or in a mixture with compounds including difimetional starter compounds such as diethylene glycol, dipropylene glycol, triethylene glycet, tripropylene glycol, butane-1,4-diol, hexane-1,6-diol. The polyols used in accordance with the invention are prepared from one or more alkylene oxides. Alkylene oxides for use with preference are oxirane, methyloxirane and ethyloxirane. These may be used alone or in a mixture. In the case of use in a mixture, it is possible to convert the alkylene oxides randomly or in blocks, or to convert them in succession. Likewise suitable are those high molecular weight polyhydroxy polyethers in which high molecular weight polyadducts or polycondensates or polymers are present in finely dispersed, dissolved or grafted form. Modified polyhydroxyl compounds of this kind are obtained, for example, when polyaddition reactions (e.g. reactions between polyisocyanates and amino-functional compounds) or polycondensation reactions (for example between formaldehyde and phenols and/or amines) are allowed to proceed in situ in the compounds having hydroxyl groups (as described, for example, in DE-B 1 168 075). Also suitable as polyol component for the process of the invention are polyhydroxyl compounds modified by vinyl polymers, as obtained, for example, by polymerization of styrene and acrylonitrile in the presence of polyethers (for example according to U.S. Pat. No. 3,383,351). Representatives of said compounds for use as starting component in accordance with the invention are described, for example, in Kunststoff-Handbuch [Polymer Handbook], volume VII “Polyurethane” [Polyurethanes], 3rd edition, Carl Hanser Verlag, Munich/Vienna, 1993, pages 57-67 and pages 88-90.

Preference is given to using, as polyol component, a mixture of one or more polyether polyols having a number-average hydroxyl number (OH number) of 250 to 600 mg KOH/g and a number-average functionality of 2.5 to 5, preferably of 2.5 to 4.

The intrinsically slow reaction to form the polyurethane can optionally be accelerated by addition of catalysts. It is possible here to use catalysts that are known per se and accelerate atalyze the reaction between hydroxyl and isocyanate groups. Especially useful are tertiary amines of the type known per se, for example triethylamine, tributylamine, N-methylmorpholine, N-ethylmorpholine, N-cocomorpholine, N,N,N′,N′-tetramethylethylenediamine, 1,4-diazabicyclo[2.2.2]octane, N-methyl-N′-ditnethylaminoethylpiperazine, N,N-dimethylcyclohexylamine, N,N,N′,N′ -tetramethyl-1,3 -butanediamine, N,N-dimethylimidazole-β-phenylethylamine, 1,2-dimethylimidazole or 2-methylimidazole. It is also possible to use organic metal catalysts, especially organic bismuth catalysts, for example bismuth(III) neodecanoate, or organic tin catalysts, for example tin(II) salts of carboxylic acids, such as tin(II) acetate, tin(II) octoate, tin(II) ethylhexanoate and tin(II) laurate, and the dialkyltin salts of carboxylic acids, for example dibutyltin diacetate, dibutyltin dilaurate, dibutyltin maleate or dioctyltin diacetate, alone or in combination with the tertiary amines. Preferably 0% to 5% by weight, especially 0.3% to 2.0% by weight, of catalyst or catalyst combination is used, based on the polyol formulation. Further representatives of catalysts and details of the mode of action of the catalysts are described in Kunststoff-Handbuch, volume VII “Polyurethane”, 3rd edition, Carl Hanser Verlag, Munich/Vienna, 1993, on pages 104-110.

The assistants and additives which can optionally be used as well include, for example, coloring agents, water-binding substances, flame retardants, plasticizers and/or monohydric alcohols.

As coloring agents, the polyol formulations of the invention may comprise, for example, organic- and/or inorganic-based dyes and/or color pigments which are known per se for the coloring of polyurethanes, for example titanium dioxide pigments, iron oxide pigments and/or chromium oxide pigments, and phthalocyanine- and/or monoazo-based pigments.

Suitable water-binding substances are both compounds having high reactivity toward water, for example tris(chloroethyl) orthoformate, and also water-binding fillers, for example alkaline earth metal oxides, zeolites, aluminum oxides and silicates. Suitable synthetic zeolites are commercially available, for example, under the Baylith® name.

Suitable flame retardants for optional additional use are, for example, tricresyl phosphate, tris(2-chloroethyl) phosphate, tris(chloropropyl) phosphate and tris(2,3-dibromopropyl) phosphate. Apart from the halogen-substituted phosphates already mentioned, it is also possible to use inorganic flame retardants such as aluminum oxide hydrate, ammonium polyphosphate, calcium sulfate, sodium polymetaphosphate or amine phosphates, for example melamine phosphates.

Examples of plasticizers include esters of polybasic, preferably dibasic, carboxylic acids with monohydric alcohols. The acid component of such esters may derive, for example, from succinic acid, isophthalic acid, trimelinic acid, phthalic anhydride, tetra- and/or hexahydrophthalic anhydride, endotnethylenetetrahydroplithalic anhydride, glutaric anhydride, maleic anhydride, fumaric acid and/or dimeric and/or trimeric fatty acids, optionally in a mixture with monomeric fatty acids. The alcohol component of such esters may derive, for example, from branched and/or unbranched aliphatic alcohols having 1 to 20 carbon atoms, such as methanol, ethanol, propanol, isopropanol, n-butanol, sec-butanol, tert-butanol, the various isomers of pentyl alcohol, of hexyl alcohol, of octyl alcohol (e.g. 2-ethylhexanol), of nonyl alcohol, of decyl alcohol, of lauryl alcohol, of myristyl alcohol, of cetyl alcohol, of stearyl alcohol and/or of fatty alcohols and wax alcohols which are naturally occurring or obtainable by hydrogenation of naturally occurring carboxylic acids. Other useful alcohol components are cycloaliphatic and/or aromatic hydroxyl compounds, for example cyclohexanol and homologs thereof, phenol, cresol, thymol, carvacrol, benzyl alcohol and/or phenylethanol. Also useful as plasticizers are esters of the abovementioned alcohols with phosphoric acid. It is optionally also possible to use phosphoric esters of halogenated alcohols, for example tirichloroethyl phosphate. In the latter case, it is possible to achieve a flame-retardant effect simultaneously with the plasticizer effect. Of course, it is also possible to use mixed esters of the abovementioned alcohols and carboxylic acids. The plasticizers may also be what are called polymeric plasticizers, for example polyesters of adipic acid, sebacic acid and/or phthalic acid. In addition, also usable as plasticizers are alkylsulfonic esters of phenol, for example phenyl paraffinsulfonate.

Further additives for optional additional use are monohydric alcohols such as butanol, 2-ethylhexanol, octanol, dodecanol or cyclohexanol, which can optionally be used in addition for the purpose of bringing about a desired chain termination.

The components of the invention are produced by layer-by-layer application to a substrate, for example by spraying. This is done by metered supply of the components of the polyurethane reactive mixture, especially isocyanate, filler-containing polyol mixture, and optionally separately the blowing agent, by means of separate conduits to a suitable mixing unit, where the outlet of the mixing unit takes the form of a spray head. Suitable mixing units are both high-pressure mixing units which work by the countercurrent injection method and low-pressure stirred mixing units.

Each of the solid layers or foam layers may advantageously be produced in several coats by spray application of the reactive mixture, such that, especially when comparatively thick layers are required, nm-off of the as yet unreacted coat which is still liquid in each case from application areas that are inclined with respect to the horizontal is avoided. In this case, the successive coats are each applied “wet on wet”, i.e. in an as yet incompletely reacted state of the coat applied beforehand, especially prior to occurrence of freedom from tack of the previous coat in each case. The first coat of the polyurethane layer of the invention is preferably also applied “wet on wet” to a last coat of a layer beneath, i.e. before freedom from tack of the layer has occurred.

The polyurethanes of the invention are especially used for production of composite components. The polyurethanes are notable for high strength and can thus be used as reinforcing coats or as pure material with high strength.

The invention is to be illustrated in detail by the examples which follow.

### EXAMPLES

Starting Compounds:

Polyol component (number-averageOH number 299 mg KOH/g, functionality 3) formed from
41.2% by weight of a polyether polyol based on ethylene oxide and propylene oxide having an OH number of 440 (molecular weight (MW): 360 g/mol), a functionality of 2.8, a propylene oxide content of 71% by weight, starter: sugar
17.4% by weight of a polyether polyol based on ethylene oxide and propylene oxide having an OH number of 470 (MW: 480 g/mol), a functionality of 4, a propylene oxide content of 87% by weight, starter: ethylenediamine
13.4% by weight of a polyether polyol based on ethylene oxide and propylene oxide having an OH number of 175 (MW: 1900 g/mol), a functionality of 6, an ethylene oxide content of 18% by weight, starter: sorbitol
12.6% by weight of a polyether polyol based on ethylene oxide and propylene oxide having an OH number of 35 (MW: 4809 g/mol), a functionality of 3, an ethylene oxide content of 17.2% by weight, starter: glycerol
6.6% by weight of castor oil (OH number of 160, functionality 2.7)
6.6% by weight of zeolite powder
0.1% by weight of diazabicyclooctane
0.2% by weight of dipropylene glycol
1.4% by weight of diethylbenzenediamine
0.4% by weight of cyclohexyldimethylamine

Isocyanate component: NCO prepolynier (NCO content: 24.78% by weight) formed from
92.5% by weight of isocyanate fanned from
   94.2% by weight of bicyclic diphenylmethane diisocyanate (MDI)
   5.2% by weight of tricyclic MDI
   0.6% by weight of tetracyclic MDI
7.5% by weight of a polyether polyol based on ethylene oxide and propylene oxide having an OH number of 175 and a number-average functionality of 3 and a propylene oxide content of 30.5% by weight and as starter: trimethylolpropane

Filler 1 (calcium carbonate): Mikhart 40 from Provencale S.A.

Filler 2 (calcium carbonate): Mikhart 65 from Provencale S.A.

Filler 3 (calcium carbonate): Calatein C16T from Provencale S.A.

Filler 4 (kaolinite): Chinafill from Quarzwerke GmbH

Filler 5 (aluminum hydroxide): Martinal ON 320 from Quarzwerke GmbH

Fillers 1 to 5 have a density of less than 2.7 g/cm³ and a Mohs hardness of 3 or less than 3.

| | | Density to | |
|---|---|---|---|
| | Median particle | ISO 787/10 in | Mohs |
| Type | diameter (d₅₀) | g/cm³ | hardness |
| Calatem C16T | 1.6 μm | 2.7 | 3 |
| Chinafill 100 | 2.0 μm | 2.6 | 2 |
| Martinal ON 320 | 20 μm | 2.4 | 2.5-3 |
| Mikhart 40 | 30 μm | 2.7 | 3 |
| Mikhart 65 | 60 μm | 2.7 | 3 |

Experimental Procedure:

Production of the Polyol Formulation:

The fillers were stirred into the polyol component and the resultant polyol formulation was then evacuated for at least 30 minutes, in order to prevent an air load in the polyol formulation.

The viscosity of the various polyol formulations at 70° C. was determined using an instrument from Haake with a measurement range of 1-60 000 mPas. For the measurements, a spindle having a diameter of 16 mm and a volume of about 7 cm³ was used. The measurements were effected at a constant speed of 150 revolutions per minute at 70° C. based on the standard DIN EN ISO 2555.

The settling characteristics were assessed visually, and the sedimented fillers were determined by measuring the height of the sedimented

The viscosity was determined in polyol formulations each containing 70% by weight of filler. The results of the viscosity measurements at 20° C. can be found in Table 1, and those at 70° C. in Table 2 below.

Table 1 shows the results with Mikhart 40 and Calatem C16T. The viscosity is reduced by the replacement of coarse fraction (Mikhart 40) with fine fraction (Calatem C16T). Over and above a ratio of 80:20, the viscosity rises again.

TABLE 1
Viscosity of the polyol formulations with
filler content 70% by weight at 20° C.

| Mikhart 40 in % by | Calatem C16T in % by | |
|---|---|---|
| weight, based on the | weight, based on the | Viscosity |
| total filler content | total filler content | [mPas] |
| 100 | 0 | 43600 |
| 95 | 5 | 33200 |
| 90 | 10 | 30000 |
| 85 | 15 | 27200 |
| 80 | 20 | 32400 |
| 75 | 25 | 36500 |

To test the processibility of the polyol formulations, the viscosity was also determined at 70° C.

TABLE 2
Viscosity of the polyol formulations with
filler content, 70% by weight at 70° C.

| Mikhart 65 in % by | Calatem C16T in % by | |
|---|---|---|
| weight, based on the | weight, based on the | Viscosity at |
| total filler content | total filler content | 70° C. [mPas] |
| 100 | 0 | not measurable; almost |
| | | complete sedimentation |
| | | of the filler |
| 95 | 5 | 3200 |
| 90 | 10 | 3500 |
| 85 | 15 | 4000 |
| 80 | 20 | 4800 |
| 75 | 25 | 5700 |

The results of the viscosity measurements at 70° C. in Table 2 show that all the viscosities determined for the polyol formulations of the invention are below the limit of 5000 mPas. The viscosity with 100% by weight of coarse filler was not measurable, since the filler had settled out almost completely. At 20° C. the viscosity passes through a minimum, whereas at 70° C. it does not appear to have any minimum, but merely rises.

As well as the viscosity measurements, after a storage time of 24 hours at 50° C. and after a period of 40 days at 20° C., the sedimented filler was analyzed. For this purpose, the polyol formulation was stored in glass vessels and the vessels were emptied after the respective storage. The evaluation was effected by measuring the sediment height in millimetres.

TABLE 3
Determination of sedimented filler after storage at 50° C. for
24 hours with Calatem C16T as fine fraction, Mikhart products
as coarse fraction and a total of 70% by weight of filler

| | | Height of the sediment in | | |
|---|---|---|---|---|
| Coarse fraction in | Fine fraction in % | millimetres after storage | | |
| % by weight, based | by weight, based | at 70° C. for 24 hours for | | |
| on the total filler | on the total filler | Mikhart | Mikhart | Martinal |
| content | content | 65 | 40 | ON 320 |
| 100 | 0 | 40 | 45 | 49 |
| 95 | 5 | 0 | 0 | 0 |
| 90 | 10 | 0 | 0 | 0 |
| 85 | 15 | 0 | 0 | 0 |
| 80 | 20 | 0 | 0 | 0 |

TABLE 4
Height of sedimented filler after storage at 20° C.
for 40 days with Calatem C16T as fine fraction, Martinal
ON 320 as coarse fraction and a total of 70% by weight of filler

| Coarse fraction in | Fine fraction in % | Height of the sediment in |
|---|---|---|
| % by weight, based | by weight, based | millimetres after storage |
| on the total filler | on the total filler | at 20° C. for 40 days |
| content | content | for Martinal ON 320 |
| 100 | 0 | 50 |
| 95 | 5 | 0 |
| 90 | 10 | 0 |
| 85 | 15 | 0 |
| 80 | 20 | 0 |

The results from Tables 3 and 4 confirm the effect of the fine filler for prevention of sedimentation.

The experiments confirm the effect of the fine fraction in the polyol formulations with high filler content. The most important features here are the prevention of the sedimentation of the filler and the low viscosity of the polyol formulations. All the filler-containing polyol formulations of the invention that have been produced are processible in a polyurethane spray system.

Production of the Polyurethanes

Batches of about 50 kg of polyol formulation were produced by means of a dissolver stirrer. When the filler was stirred into the polyol formulation, first the coarse filler and then the fine filler was incorporated. There was no additional heat treatment of the filler-containing polyol formulation. After the desired amount of filler had been incorporated, the filler-containing polyol formulation was homogenized at least for another 20 minutes and then evacuated.

For the production of the polyurethane, the isocyanate component was added to the filler-containing polyol formulation. The index was 110. The index is defined as the molar ratio of the reactive groups in the isocyanate component (moles of NCO) to the reactive groups in the polyol formulation (moles of OH); the ratio is then multiplied by 100.

For the processing of the filler-containing polyol formulation and the isocyanate component, a polyurethane reaction machine from Unipre was used. The raw materials (filler-containing polyol formulation and isocyanate component) were heated to 75° C. in the system and conveyed at a constant volume flow rate of about 1.8 l/min. By layer-by-layer application, sheets having a thickness of about 4 mm with a length and width of about 400 mm each case were produced. Standard test specimens were then sawn out of these sheets for the examination of the mechanical properties. The measurements were conducted to DIN EN ISO 178.

TABLE 5
Results of the measurements of the mechanical values of the polyurethane
sheets produced with different filler combinations at a filler
content of 70% by weight in the polyol formulation and with a
fine fraction of 15% to a coarse fraction of 85%

| | | Modulus of | Maximum | Elongation |
|---|---|---|---|---|
| | Coarse | Elasticity | force | at break |
| Fine fraction | fraction | [MPa] | [MPa] | [%] |
| Calatem C16T | Mikhart 65 | 6330 ± 140 | 55.0 ± 0.7 | 1.58 ± 0.04 |
| Calatem C16T | Mikhart 40 | 6417 ± 94 | 56.8 ± 0.7 | 1.55 ± 0.09 |
| Calatem C16T | Martinal | 6413 ± 87 | 59.7 ± 1.0 | 1.13 ± 0.03 |
| | ON320 | | | |

The mechanical properties measured demonstrate that, in general, a modulus of elasticity of about 6000 MPa or more is attained. The maximum force is about 55 MPa. Elongation at break is 1.1% to 1.6%.

1-6. (canceled)

7. A filler-containing polyol formulation consisting of
i) a polyol component having a number-average OH number of 250 to 600 mg KOH/g and a number-average functionality of 2.5 to 5, containing at least one or more than one polyol,
ii) optionally chain extenders and/or crosslinkers,
iii) optionally catalysts and/or activators,
iv) optionally assistants and/or additives,
v) optionally blowing agents,
vi) at least one filler from the group consisting of calcium carbonate, kaolinite, aluminum hydroxide and talc in an amount of 50% to 75% by weight, based on the polyol formulation,
wherein a coarse fraction of filler particles having d₅₀ of 30 to 80 μm in an amount of 80% to 97.5% by weight, based on the filler, and a fine fraction of filler particles having d₅₀ of 0.5 to 2 μm in an amount of 2.5% to 20% by weight, based on the filler, are present in the at least one filler and the filler does not sediment for up to 40 days at 20° C., and wherein the viscosity of the polyol formulation at 70° C. is below 5000 mPas.

8. A filler-containing polyurethane comprising the reaction product of
a) a filler-containing polyol formulation consisting of
i) a polyol component having a number-average OH number of 250 to 600 mg KOH/g and a number-average functionality of 2.5 to 5, containing at least one or more than one polyol,
ii) optionally chain extenders and/or crosslinkers,
iii) optionally catalysts and/or activators,
iv) optionally assistants and/or additives,
v) optionally blowing agents,
vi) at least one filler from the group consisting of calcium carbonate, kaolinite, aluminum hydroxide and talc in an amount of 50% to 75% by weight, based on the polyol formulation,
wherein a coarse fraction of filler particles having d₅₀ of 30 to 80 μm in an amount of 80% to 97.5% by weight, based on the filler, and a fine fraction of filler particles having d₅₀ of 0.5 to 2 μm in an amount of 2.5% to 20% by weight, based on the filler, are present in the at least one filler and the filler does not sediment for up to 40 days at 20° C., and wherein the viscosity of the polyol formulation at 70° C. is below 5000 mPas, and
b) at least one di- and/or polyisocyanate component.

9. A component consisting of at least one polyurethane as claimed in claim 8 and optionally a substrate or optionally one or more layers.

10. A component consisting of at least one polyurethane as claimed in claim 8 and a substrate or at least one or more than one layer.

11. A composite component consisting of at least one layer of a polyurethane as claimed in claim 8 and at least one or more than one layer.

12. A process for producing composite components having at least one filler-containing polyurethane layer formed from a filler-containing polyol formulation and at least one di- and/or polyisocyanate component and at least one substrate or at least one layer, by spray methodology, comprising
a) blending at least one filler from the group consisting of calcium carbonate, kaolinite, aluminum hydroxide and talc in an amount of 50% to 75% by weight, based on the filler-containing polyol formulation, with a polyol formulation consisting of
i) a polyol component having a number-average OH number of 250 mg KOH/g to 600 mg KOH/g and a number-average functionality of 2.5 to 5, containing one or more polyols,
ii) optionally chain extenders and/or crosslinkers,
iii) optionally catalysts and/or activators,
iv) optionally assistants and/or additives,
v) optionally blowing agents,
to give a polyol formulation having a viscosity at 70° C. of less than 5000 mPas (to DIN EN ISO 2555 at 70° C.),
wherein a coarse fraction of filler particles having d₅₀ of 30 to 80 μm in an amount of 80% to 97.5% by weight, based on the filler, and a fine fraction of filler particles having d₅₀ of 0.5 to 2 in an amount of 2.5% to 20% by weight, based on the filler, are present in the at least one filler and the filler does not sediment for up to 40 days at 20° C.,
b) mixing the filler-containing polyol formulation from a) in a spray head with at least one di- and/or polyisocyanate component to give a mixture,
c) spraying the mixture from b) onto a substrate or a layer and curing.
